(19) United States
(12) Patent Application Publication
(10) Pub. No.: US 2020/0385951 A1
(43) Pub. Date: Dec. 10, 2020

(54) ROTOMOLDED REINFORCED CONCRETE METER BOX LID AND METHOD OF MAKING SAME

(71) Applicant: SIGMA CORPORATION, Cream Ridge, NJ (US)

(72) Inventors: Stuart J. BOX, Cropwell, AL (US); Chad D. ARCHER, Caldwell, ID (US)

(21) Appl. No.: 16/434,242

(22) Filed: Jun. 7, 2019

(51) Int. Cl. E02D 29/14; B29C 41/04; B29C 41/20; B28B 1/30; B32B 13/12

(52) U.S. Cl. CPC E02D 29/1454; B29C 41/04; B29C 41/20; B29K 2023/065; B32B 13/12; E02D 29/1472; B28B 1/30

(57) ABSTRACT

A rotomolded lid for a meter box and a method of making the same are provided. The lid is formed in a rotomold process that embeds a pair of rebars within a hollow lid product. Concrete is then poured into the hollow portion and allowed to cure. The end result is a reinforced meter box lid that is configured to handle loads of up to 16,000 lbs. In addition, the presence of the rebars, which are ferromagnetic, allows a metal detector to detect the presence of the lid should it ever be inadvertently covered over or otherwise obscured from view. Furthermore, the central lid portion may also include a passageway covered by a hinged door to permit access to the meter box without having to lift up the lid itself. Another passageway, along with an associated countersunk portion in an upper lid surface, permits a wireless transponder to be positioned therein and connected to meter equipment in the box.

### BACKGROUND OF THE INVENTION

The present invention relates generally to meter box lids and, more particularly, to a rotomolded hollow lid body having a pair of rebars therein and which is then filled with concrete.

The general understanding in today's market is that a meter box and lid combination should be able to support a vertical load of at least 16,000 lbs. for vehicles, bicycles, people, etc., traveling over the lid. The simple solution for that is to supply a standard ductile iron lid and the vertical load is easy to achieve. However, with the rapid deployment of remote sensing (viz., meter reading) technology, it is widely accepted that ductile iron lids do not allow for good transmission from the sending unit in the meter to the remote collection and storage locations for the data. As such, plastic is the preferred material for lids. Examples of such plastic lids are provided in the following U.S. Pat. No. 3,952,908 (Carson); U.S. Pat. No. 5,123,776 (Lang); U.S. Pat. No. 6,968,969 (McKinnon, Jr.); U.S. Pat. No. 7,353,966 (McKinnon, Jr.); U.S. Pat. No. 7,500,578 (McKinnon, Jr.).

However, although plastic lids have better properties for transmission of data, they fall short in several aspects, namely, (1) plastic is buoyant and will float on water if the meter box is flooded; (2) many times the lid gets buried or is inadvertently covered over and needs to be located; one method of detecting a hidden ductile iron lid is to use a metal detector; but this detection method is rendered useless if the covered lid comprises plastic since plastic is not detectable with a metal detector; and (3) plastic in rotomolding is hollow and does not have enough strength to support even 5000 lbs.

So while the devices of the aforementioned patents are suitable for their intended purposes, they nevertheless leave something to be desired as discussed above. Thus, a need exists for a meter box lid cover which overcomes the drawbacks of the prior art. The subject invention addresses that need.

All references cited herein are incorporated herein by reference in their entireties.

### BRIEF SUMMARY OF THE INVENTION

A lid configured for being positioned on top of a meter box is disclosed. The lid comprises: a body, formed of a plastic material (e.g., a high density polyethylene (HDP)), having a hollow interior that is filled with cement (e.g., a lightweight polymer concrete) that includes a pair of rebars for reinforcing the lid and for making the lid detectable by a metal detector.

A method of forming a lid configured to be positioned on top of a meter box is disclosed. The method comprises: (a) providing a mold corresponding to the shape of the lid; (b) inserting a plurality of shaft collars within the mold; (c) positioning a pair of rebars in the mold, wherein the rebars are placed in parallel to each other; (d) pouring in a high density polyethylene pigment or powder within the mold; (e) securing a top over the mold to form a mold assembly; (f) rotomolding the mold assembly in a rotomold oven at a predetermined temperature for a first predetermined time cycle; (g) cooling the mold assembly for a first time; (h) slowly rotating mold for a second predetermined time cycle to form a molded lid having a hollow interior; (i) cooling the mold assembly for a second time; (j) stripping the molded lid from the mold; and (k) pouring concrete into the hollow interior of the molded lid.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an exploded view showing the inventive lid being positioned over an exemplary in-ground meter box and how a wireless transponder device is inserted therein; FIG. 2A is a cross-sectional view of the inventive lid of FIG. 1 but before the concrete fill is poured into the lid and is taken along line 2A-2A of FIG. 1;

FIG. 2B is a cross-sectional view of the inventive lid of FIG. 1 taken along line 2B-2B;

FIG. 3A depicts the inventive lid positioned in its cover position over the in-ground meter box but obscured by ground debris and a metal detector detecting the presence of the inventive lid due to the ferromagnetic rebars within the lid;

FIG. 4 depicts the inventive lid positioned in its cover position over the in-ground meter box but with the flip reader in an open position;

FIGS. 5A-5B form a flow diagram of the formation process of the inventive lid of the present application;

FIG. 6A is a view of an exemplary mold for forming the rotomolded lid of the present invention and showing the two rebars secured therein using collars; and

FIG. 6B is a view of an exemplary mold lid that mates with the mold of FIG. 6B for forming the rotomolded lid of the present invention.

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

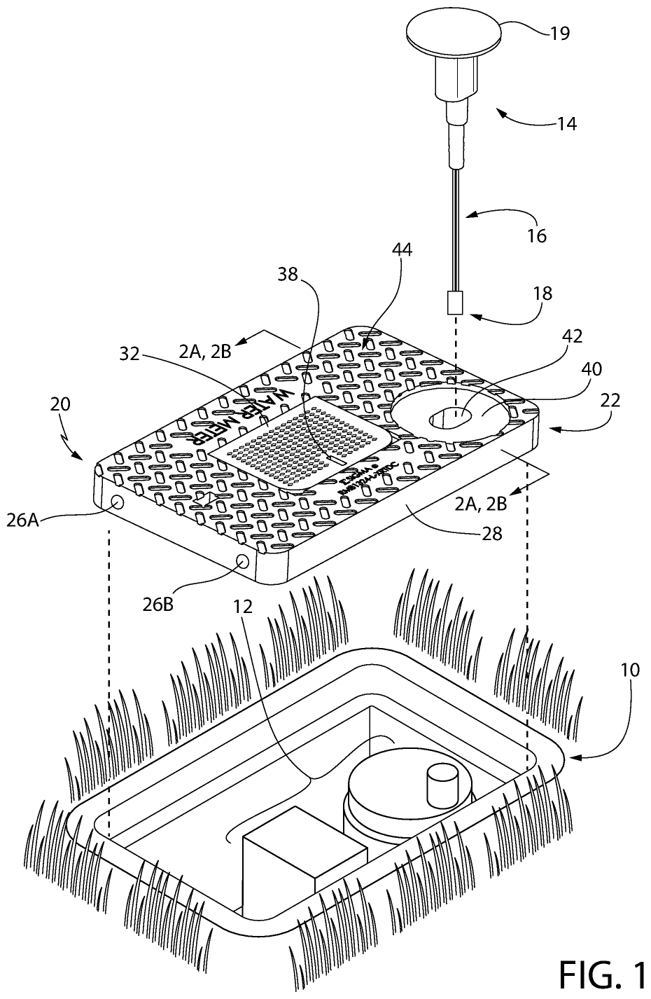

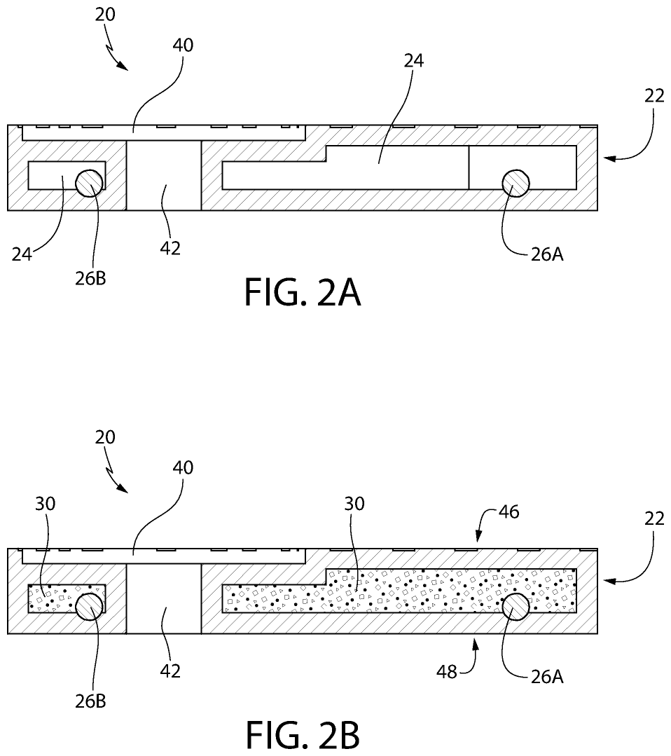

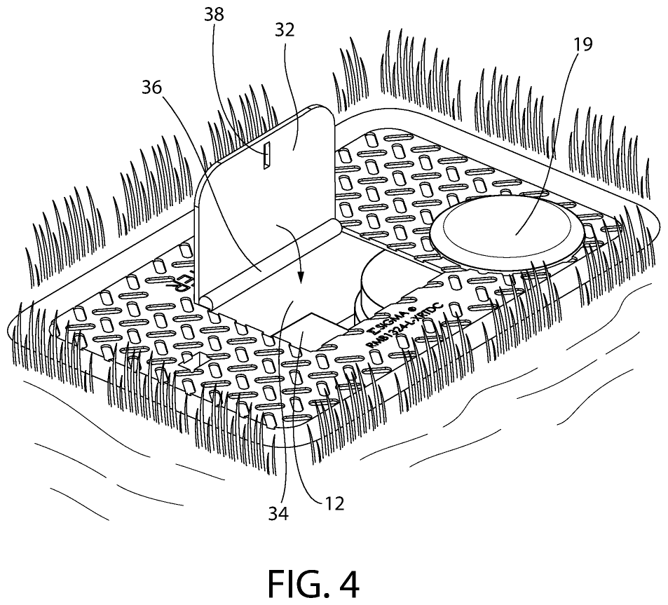

FIG. 1 depicts the inventive lid 20 of the present application being oriented for receipt within the top of an exemplary in-ground meter box 10 which contains meter equipment 12 (e.g., water meters, electrical meters, etc.); these meter boxes 10 typically comprise a rounded rectangularly-shaped opening with rounded corners. As will be discussed in detail later, the lid 20 comprises a durable plastic material that is rotomolded into a rectangularly-shaped body 22 with rounded corners and having a substantially hollow interior 24 and wherein a pair of steel reinforcing bars (hereinafter “rebars”) 26A and 26B are positioned and secured therein, running parallel to the longer edge 28 of the lid 20. As will also be discussed later, the hollow interior 24 is then filled with a concrete material (or even a lightweight polymer concrete) 30 (FIG. 2B) to make the lid 20 weighted sufficiently so that traffic or other loads that pass over the lid 20 when acting as a cover (hereinafter referred to as the “cover position”) to the in-ground meter box 10, the lid 20 cannot be inadvertently pivoted, nor float on water (if the meter box 10 floods with water) or otherwise displaced, out of the cover position (FIG. 4). Once the lid formation process is completed (as will be discussed later), the lid 20 is capable of supporting 16,000 lbs. when in the cover position.

Another option is that the lid 20 may also comprise a door 32 (also referred to as a “flip reader”) that is hinged within an opening of passageway 34 (FIG. 4) in the lid 20. The flip reader 32 may comprise a cast iron or steel element that is coupled at one side of the opening of a passageway 34 of the lid 20 via a hinge 36; e.g., the two ends of a hinge pin 36 may be secured within holes (not shown) drilled on opposite edges of the one side of the passageway opening 34, as shown in FIG. 4. The flip reader 32 may also comprise a slit or aperture 38 that permits a service technician with the ability to insert a finger or tool to open the flip reader 32 if access to the meter equipment 12 is required without having to lift the entire lid 20 out of the cover position, due to its heavy weight.

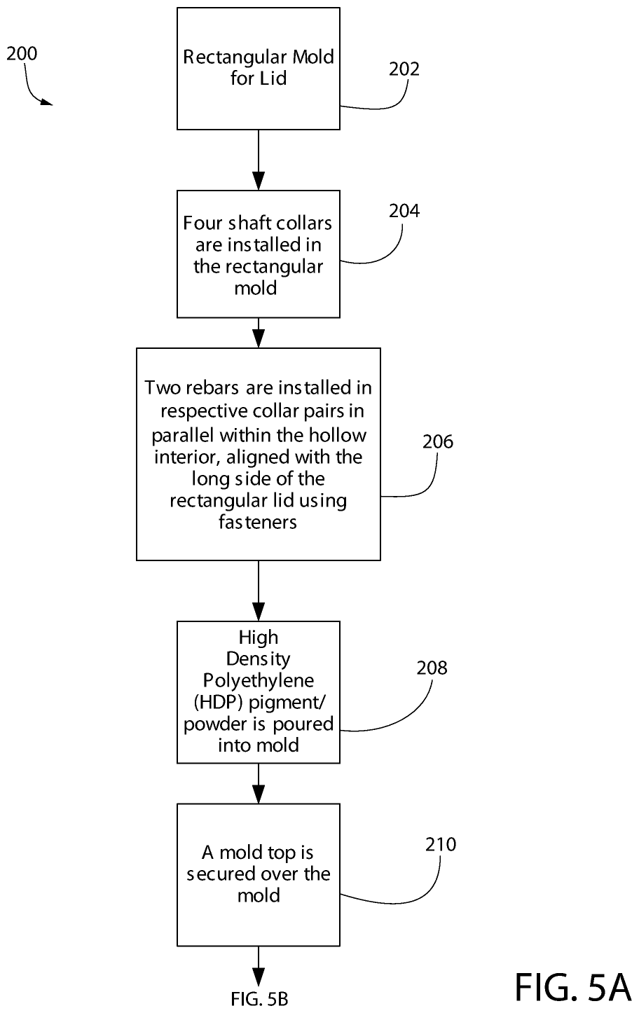

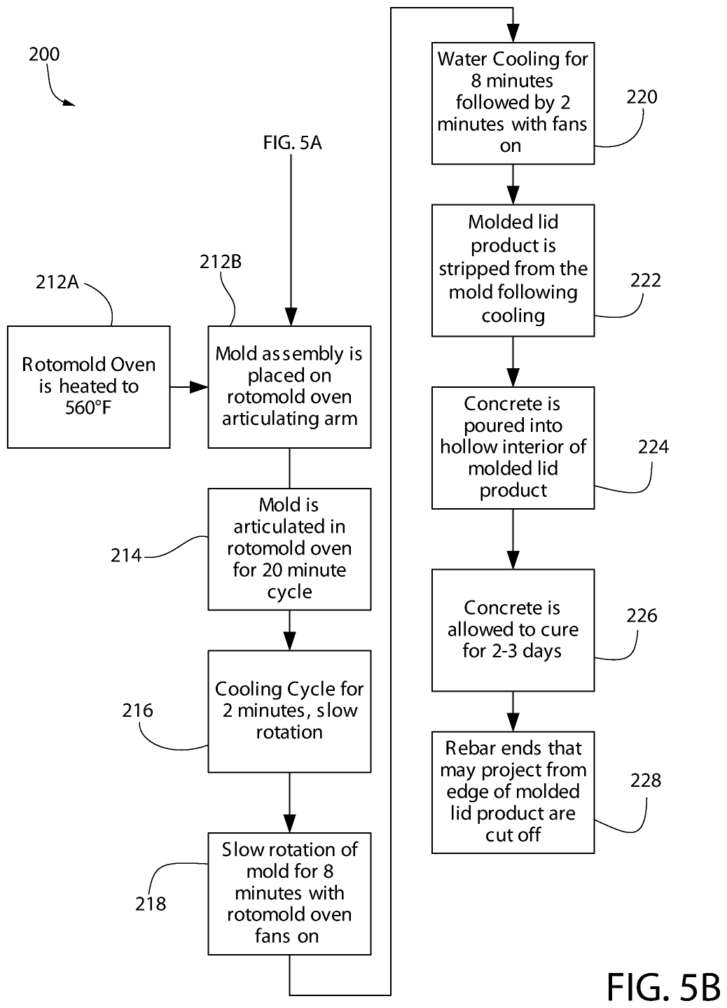

In addition, lid 20 also comprises a countersunk portion 40 in the lid top surface 46 (FIG. 2B) and associated passageway 42 (FIG. 5) which is configured for receiving a wireless transponder device 14 therein for permitting meter data communication between the meter equipment 12 and a remote location (not shown). As shown most clearly in FIG. 1, a wireless transponder device 14 (e.g., a wireless transponder device disclosed in U.S. Pat. No. 6,177,883 (Jennetti, et al.), which is incorporated by reference in its entirety) is electrically coupled to the meter equipment 12 via a wire harness 16 and connector 18 (e.g., an AMR-compatible wire harness/connector) that pass through the passageway 42 for connection to the meter equipment 12 and then the planar disc-shaped antenna portion 19 of the wireless transponder device 14 is seated within the countersunk portion 40, as shown in FIGS. 1 and 4, for example). This countersunk portion 40 permits the antenna 19 to be substantially planar or flush with the upper surface 46 of the lid 20 when the device 14 is installed.

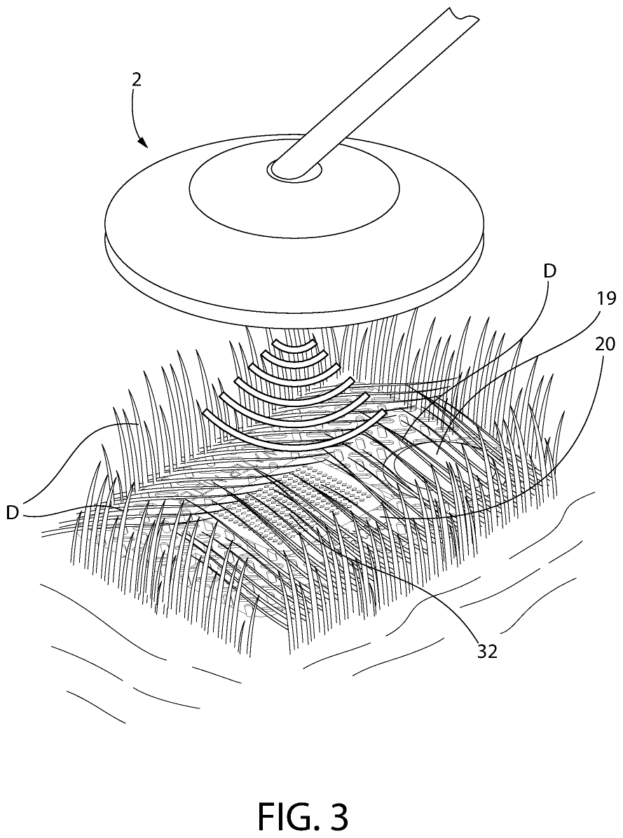

As mentioned previously, one problem with meter box lids is that they are prone to being inadvertently covered by something (e.g., items, vehicles, or anything this may be sitting on top of the lid 20, all of which are hereinafter referenced as “debris D”), thereby obscuring their location. When the service technician arrives to service any part of the meter equipment 12, he/she may find it difficult to locate the meter box 10 due to the presence of debris D on the lid 20. To facilitate the locating of the meter box 10, as mentioned previously, the inventive lid 20 comprises a pair of rebars 26A/26B (e.g., 5/8-inch diameter rebars) that are embedded within the lid 20. Not only does the presence of the rebars 26A/26B strengthen the lid 20 in combination with the cement 30, but their ferromagnetic characteristic allows a metal detector 2 to detect them, and thereby identifying the presence of the meter box 10 that is obscured, as shown in FIG. 3. Furthermore, if the lid 20 also includes the flip reader 32, the ferromagnetic characteristic of the reader 32 also enhances the ability of the metal detector 2 to also detect that element (in addition to the two rebars 26A/26B) in establishing the presence of an obscured lid 20.

The upper surface of the lid 20 may also comprise a plastic “diamond plate” textured appearance 44 that is normally found in aluminum sheeting used for access panels in flooring in order to give the inventive lid 20 a similar connotation that it is a meter box lid.

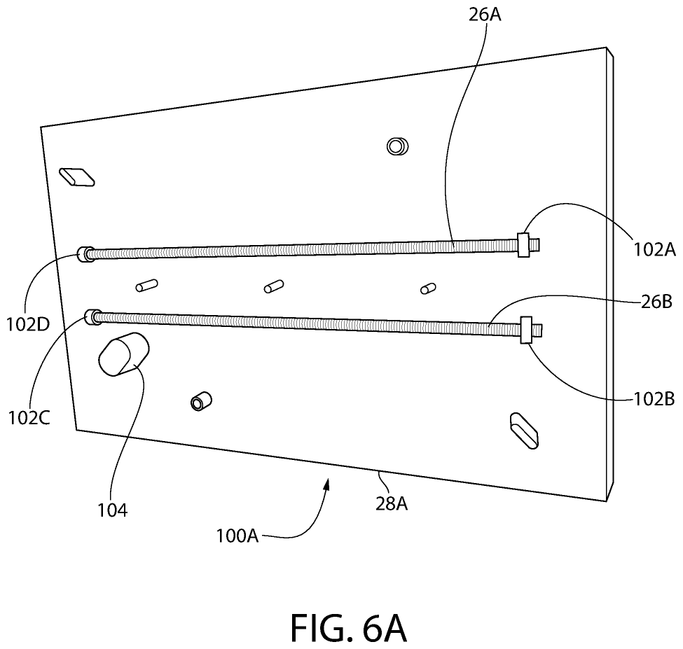

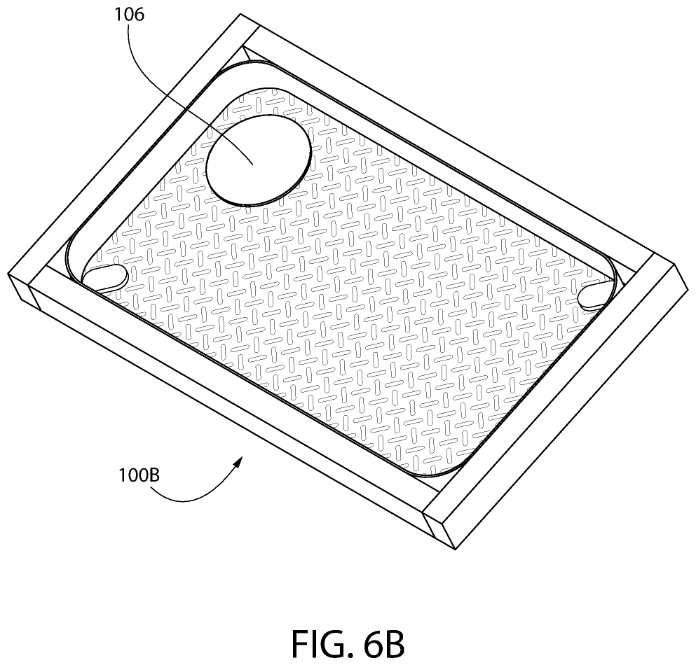

As mentioned previously, the inventive lid 20 comprises a hollow plastic material body 22 that is then filled with a concrete material 30. In particular, FIGS. 5A-5B set forth the lid formation process 200. In step 202, a rectangular mold 100A (FIG. 6A) is provided that corresponds to the desired size of the lid 20. In step 204, four collars 102A-102D (FIG. 6A) are installed within the mold 100A. In step 206, the two rebars 26A/26B are respectively secured within collars 102A/102D and 102B/102C in an orientation that has them aligned with a long side 28A (FIG. 6A) of the rectangular mold 100A; the collars 102A-102D are secured within the mold using fasteners (not shown). With the collars 102A-102D and rebars 26A-26B in place in the mold 100A, in step 208 a high density polyethylene (HDP) pigment/powder is poured into the mold. In step 210, a mold top 100B with rounded corners (FIG. 6B) is placed over the mold to enclose the HDP pigment/powder, rebars and collars therein, forming a mold assembly. As can be seen in FIG. 6B, a raised circular projection 106 aligns with an oval-shaped tube 104 (FIG. 6A) to form the countersunk portion 40 and passageway 42 for the wireless transponder device 14. (It should be noted that the mold/mold top 100A/100B shown in FIGS. 6A-6B omits a projection for forming the passageway 34 that is then covered by the hinged door 32 since the mold/mold top 100A/100B of FIGS. 6A-6B are used to form a rotomolded lid 20 that has no central passageway 34).

In step 212A, a rotomold oven (e.g., Ferry Industries MOD RS-220 Rotational Molder Machine) is heated to 560° F. The mold assembly is then secured to an articulating arm within the rotomold oven in step 212B. The articulating arm is then energized in the rotomold oven for a 20 minute cycle in step 214. Next, in step 216, a cooling cycle for 2 minutes with a slow rotation is instituted. In step 218, a slow rotation of the mold assembly is made for 8 minutes with the rotomold oven fans on. In step 220, water cooling of the mold assembly is activated for 8 minutes followed by 2 minutes with fans on. In step 222, the mold assembly is removed from the oven, the mold lid removed, and the molded lid product is stripped from the mold. Step 222 includes a trimming phase where the molded lid product is trimmed and which also includes drilling holes within the molded lid product at the sides of the opening 34 (see FIG. 4) and then inserting the hinge pin 36 in the holes while installing the door 32 therein. In step 224, concrete or a lightweight polymer concrete is poured into the hollow portion 24 of the lid 20. In step 226, this concrete is allowed to cure for 2-3 days. If the rebars 26A/26B placed in the mold originally are longer than the long side 28 of the mold, the excess portions of the rebars 26A/26B are cut off in step 228 to provide a smooth side to the lid 20.

It should be noted that, as mentioned previously, the installation of the hinged door 32 within the lid 20 is an option. Thus, the inventive lid 20 may comprise no hinged door 32 in which case the central portion of the lid 20 is continuous.

While the invention has been described in detail and with reference to specific examples thereof, it will be apparent to one skilled in the art that various changes and modifications can be made therein without departing from the spirit and scope thereof.

1. A lid configured for being positioned on top of a meter box, said lid comprising: a body, formed of a plastic material, having a hollow interior that is filled with cement that includes a pair of rebars for reinforcing said lid and for making said lid detectable by a metal detector.

2. The lid of claim 1 wherein said body is formed into a rectangular shape having rounded corners, said rectangular shape having rounded corners permitting said body to fit snugly into the opening of a correspondingly-shaped opening at the top of the meter box.

3. The lid of claim 2 wherein said pair of rebars are positioned in parallel and are aligned with a long side of said rectangularly-shaped body.

4. The lid of claim 1 further comprising a passageway formed in a central region of said body from a top side to a bottom side of said body and wherein a door is pivotally hinged within said passageway, said door being openable to permit access through said lid without having to raise the lid when said lid is positioned on top of the meter box.

5. The lid of claim 4 wherein said door comprises a slit for permitting a user to insert a finger or a tool therein to open said door.

6. The lid of claim 1 further comprising a passageway from a top side to a bottom side of said body, said passageway on said top side comprising a countersunk portion to permit placement of a disc-shaped antenna portion of a wireless transponder therein.

7. The lid of claim 1 wherein said body comprises a top side and a bottom side, said top side further comprising a diamond-plate texture appearance.

8. The lid of claim 1 wherein said lid supports a weight of up to 16,000 pounds.

9. A method of forming a lid configured to be positioned on top of a meter box, said method comprising:
(a) providing a mold corresponding to the shape of said lid;
(b) inserting a plurality of shaft collars within said mold;
(c) positioning a pair of rebars in said mold, said rebars being placed in parallel to each other;
(d) pouring in a high density polyethylene pigment or powder within said mold;
(e) securing a top over said mold to form a mold assembly;
(f) rotomolding said mold assembly in a rotomold oven at a predetermined temperature for a first predetermined time cycle;
(g) cooling said mold assembly for a first time;
(h) slowly rotating mold for a second predetermined time cycle to form a molded lid having a hollow interior;
(i) cooling said mold assembly for a second time;
(j) stripping said molded lid from said mold; and
(k) pouring concrete into said hollow interior of said molded lid.

10. The method of claim 9 further comprising the step of cutting off any portion of the pair of rebars that may project from said molded lid.

11. The method of claim 9 wherein said first predetermined time cycle comprises 20 minutes.

12. The method of claim 9 wherein said predetermined temperature comprises 560° F.

13. The method of claim 9 wherein said second predetermined time cycle comprises 8 minutes with fans of said rotomold oven being active.

14. The method of claim 9 wherein said step of cooling said mold assembly for the first time comprises cooling said mold assembly for 2 minutes, with a slow rotation.

15. The method of claim 9 wherein said step of cooling said mold assembly for the second time comprises water cooling said mold assembly for 8 minutes followed by two minutes with fans of said rotomold oven being active.

16. The method of claim 9 wherein said step of pouring concrete into said hollow interior of said molded lid further comprises allowing said concrete to cure for 2-3 days.

17. The method of claim 9 wherein said step of providing a mold corresponding to the shape of said lid comprises providing a mold having a rectangular shape with rounded corners.

18. The method of claim 17 wherein said step of positioning the pair of rebars in said mold comprises orienting said pair of rebars to be aligned with a long side of said mold.

19. The method of claim 9 wherein said step of providing a mold permits the formation of a passageway in a central portion of said lid and wherein step (j) further comprises:
(1) trimming said mold;
(2) drilling holes in sides of said passageway in a first surface of said lid; and
(3) installing a hinge pin and door within said holes to establish a hinged door over said passageway in said central portion of said lid.

20. The method of claim 19 wherein said step of providing a mold permits the formation of a countersunk portion being formed in a first surface of said lid and an associated passageway to a second surface, opposite said first surface, in said lid, said countersunk portion and said passageway being configured to receive a wireless transponder therein.
